(19) United States
(12) Patent Application Publication
(10) Pub. No.: US 2026/0274436 A1
(43) Pub. Date: Sep. 17, 2026

(54) GUILLOTINE SYSTEM, IN PARTICULAR FOR AN IN-FLIGHT REFUELING DEVICE

(71) Applicant: SAFRAN AEROSYSTEMS, Plaisir (FR)

(72) Inventor: Rémi BATTARRA, MOISSY-CRAMAYEL (FR)

(73) Assignee: SAFRAN AEROSYSTEMS, Plaisir (FR)

(21) Appl. No.: 19/167,082

(22) PCT Filed: Mar. 21, 2024
(86) PCT No.: PCT/FR2024/050354

§ 371 Date: Sep. 19, 2025

(30) Foreign Application Priority Data
Mar. 24, 2023 (FR) FR2302548
Jul. 21, 2023 (FR) FR2307737

(51) Int. Cl. B64D 39/06; B64D 39/02; B64D 39/04

(52) U.S. Cl. CPC B64D 39/06; B64D 39/02; B64D 39/04

(57) ABSTRACT

The A guillotine system, in particular for an in-flight refueling device, includes a passage through which a pipe is able to pass, a blade movable between a first position, in which the pipe is able to slide freely through the passage, and a second position, in which the blade is able to cut the pipe. The system further includes an actuator of the non-pyrotechnic type configured to contain and/or generate a pressurized fluid released to move the blade from the first position to the second position.

### TECHNICAL FIELD OF THE INVENTION

The present invention relates to the general field of the aeronautics aimed more particularly at a guillotine system, in particular for an in-flight refueling device for an aircraft, as well as an aircraft comprising such an in-flight refueling device.

### TECHNICAL BACKGROUND

The technical background comprises the documents US-A1-2014/346279, WO-A1-02/24529, US-A 1-2002/074455, US-A 1-2019/257710 and EP-A 1-4 032 809.

During a flight, an aircraft is known to be refueled by transferring at least one fluid, such as fuel, to it.

This is the case, for example, when an aircraft may not or must not land in an area over which it is flying. The aircraft must then be refueled in-flight. This is particularly the case when the volume of fuel on board reaches a lower threshold value.

During such refueling, as shown schematically in FIG. 1, a first aircraft 14, also referred to as a tanker 14 or refueling aircraft 14, is equipped with an in-flight refueling device to which a second aircraft 22, also referred to as a receiver 22 or aircraft to refuel 22, is connected.

The in-flight refueling device comprises a pipe 10 configured to transfer fluid, unwound from the first aircraft to the second aircraft, which is located downstream of the first aircraft, in the direction of flight, and which is to be refueled.

The pipe 10 may be unwound or deployed from a downstream end of a fuselage 12 of the refueling aircraft 14, as shown in FIG. 1, or from a wing of the refueling aircraft 14.

Alternatively, the pipe 10 may be deployed from a carrier, also referred to as a nacelle, installed on the ventral point of an aircraft, in particular a fighter aircraft, or from a carrier installed under the wing of an aircraft, in particular a refueling aircraft or a fighter aircraft. The pipe 10, suitable for transferring fluid, comprises a first end 10a, connected to a fluid source 16, and comprising for example a reservoir and a pump, and a second end 10b, opposite the first end 10a, and comprising a first connector 18.

The first connector 18 is configured to provide a fluidic connection with a second connector 20, which may cooperate in a complementary manner. The second connector 20 is carried, in particular by a boom, from the aircraft to be refueled 22. This type of connection is well known to the person skilled in the art.

The first connector 18 comprises, for example, a pressure-limiting member 24 and a frustoconical basket 26. To this end, the connector 18 may comprise a valve allowing the pressure at the outlet of the first connector 18 to be set to the limit prevailing in the medium. The frustoconical basket 26 helps to center and guide the second connector 20 inside the first connector 18. To this end, the second connector 20 has a pointed shape which cooperates with the pressure-limiting member 24 of the first connector 18.

The frustoconical basket 26 is also shaped to facilitate a centering of the first connector 18 in the air flow. The pipe 10 is unwound by means of a pipe 10 deployment system located inside the refueling aircraft 14 or inside the carrier of the refueling aircraft 14.

When the refueling aircraft 14 takes off, the pipe 10 is wound. During a refueling operation, the unwinding of the pipe 10 is controlled so as to unwind a sufficient length of the pipe 10, for example over several tens of meters, in particular a length of between 15 meters and 30 meters, so that the first connector 18 approaches the second aircraft 22 and may be connected to the second connector 20 of the second aircraft 22.

The pipe 10 is relatively flexible and is likely to move and shift as it is unwound and subjected to disturbances downstream of the first aircraft 14 or to turbulence.

If the movements of the pipe 10 are too great and uncontrolled, they could come into contact with the refueling aircraft 14 and/or the second aircraft 22.

In addition, when the movements of the pipe 10 occur when the second connector 20 of the second aircraft 22 is connected to the first connector 18 of the refueling aircraft 14, it is then necessary for the second aircraft 22 to clear the area subject to the disturbances downstream of the first aircraft 14 or to turbulence. As a last resort, it may be possible to cut the pipe 10 if it may not be rewound.

Furthermore, after refueling, there is a risk that the first connector 18 of the refueling aircraft 14 and the second connector 20 of the second aircraft 22 will not disengage from each other. In this case, the second connector 20 acts as a mechanical fuse.

Finally, there is also a risk that the pipe deployment system will jam and that it will no longer be possible to rewind the pipe once it has been deployed.

In such cases, it is necessary to cut the pipe to abandon the unwound part of the pipe and prevent it from creating a risk for the refueling aircraft and/or the aircraft to be refueled. For example, the pilot of the refueling aircraft may decide to cut the pipe before landing the refueling aircraft 14.

It is known to associate to the pipe a guillotine system comprising a passage through which the pipe passes and a blade movable between a first position, in which the pipe may slide freely through the passage, and a second position, in which the blade cuts the pipe in order to sever it in two.

Such a guillotine system comprises an actuator configured to be activated by a control circuit located, in general, in the cockpit of the refueling aircraft. When the pilot of the refueling aircraft activates the control circuit, a signal is sent to the actuator which triggers a movement of the blade from the first position to the second position.

In the present technique, the actuator is of the pyrotechnic type, i.e. it comprises an explosive charge and a detonator which ignites the explosive charge when it receives the aforementioned signal. Igniting the charge releases a high level of pressure which moves the blade to sever the pipe.

The advantage of this solution is that the pipe may be cut at any point along its length. In addition, it allows the guillotine system to have a good reactivity of the order of a few milliseconds following signal remission.

However, this technology, described for example in the document FR-A-1 590 598, has its disadvantages.

The first disadvantage is that the explosive charge is subject to strict regulations requiring it to be disarmed daily. Human intervention is required to disarm and reset the actuator every day, which may lead to operating errors, such as incorrect connections, or forgotten connections, such as connecting an electrical harness.

Another disadvantage is the obsolescence of this type of actuator, which has to be replaced regularly because it has a relatively short service life. Moreover, the use of this type of actuator may be called into question by new regulations, such as REACH, which aims to ensure the safe manufacture and use of chemical substances in European industry.

Another disadvantage is that it is not possible to monitor the state of such an actuator once it has been fitted to a refueling aircraft. An alternative to cutting the pipe is to abandon the entire pipe rather than just a cut portion. To achieve this, the pipe deployment system comprises an electromechanical pipe release system. However, this is not an ideal alternative either, as the pipe needs to be fully unwound in order to be released, and the pipe deployment system may jam even when the pipe is not fully unwound.

The purpose of the present invention is to provide a solution to at least some of the problems of the prior art which is simple, effective and economical.

The invention relates to a guillotine system, in particular for an in-flight refueling device, comprising
a passage, through which a pipe is able to pass,
a blade movable between
   a first position, in which the pipe is able to slide freely through the passage, and
   a second position, in which the blade is able to cut the pipe, in particular in order to sever it in two, and
an actuator, in particular one that may be activated by a control circuit, configured to move the blade from the first position to the second position.

In particular, the actuator is of the non-pyrotechnic type. The actuator is therefore not subject to the constraints and disadvantages of the prior art.

In addition, the actuator is configured to contain and/or generate a pressurized fluid released to move the blade from the first position to the second position.

The present invention offers several non-pyrotechnic solutions for the actuator.

In the present application, a non-pyrotechnic actuator is to be understood as being a non-explosive or non-sparking actuator, i.e. one which does not generate an explosion or spark during its use.

In a first aspect, the actuator comprises a cartridge adapted to contain a volume of a pressurized gas. Such pressurized gas is configured to be released, in particular following an activation by the control circuit, so as to ensure a movement of the blade from the first position to the second position.

The invention thus proposes replacing the pyrotechnic guillotine system of the prior art with a pneumatic guillotine system.

The invention solves at least some of the disadvantages described above. Firstly, the cartridge containing the pressurized gas is not subject to strict regulation and must not be disarmed. It therefore requires less or no human intervention. The cartridge containing the pressurized gas has a service life longer than an explosive charge. Such a cartridge may also be instrumented to monitor its state over time, which was not possible in the prior art. According to a second aspect of the invention, the actuator comprises an accumulator, adapted to contain a volume of pressurized liquid. Such pressurized liquid is configured to be released so as to move the blade from the first position to the second position.

The invention thus proposes to replace the pyrotechnic guillotine system of the prior art by a hydraulic or hydromechanical guillotine system.

The invention solves at least some of the disadvantages described above. Firstly, the accumulator containing the pressurized liquid is not subject to strict regulation and must not be disarmed. It therefore requires less or no human intervention. The accumulator containing the pressurized liquid has a service life longer than an explosive charge. In addition, such an accumulator may be instrumented to monitor its state over time, which was not possible in the prior art.

According to a third aspect of the invention, the actuator comprises a container able to contain chemical reagents, in particular separated from each other and able to be mixed and/or brought into contact to generate a pressurized gas. Such a pressurized gas is then released to move the blade from the first position to the second position.

The invention thus proposes to replace the pyrotechnic guillotine system of the prior art by a chemical reaction guillotine system. The invention allows to solve at least some of the disadvantages described above. Firstly, the container containing the chemical reagents is not subject to strict regulations and must not be disarmed. It therefore requires less or no human intervention. The container containing the chemical reagents has a longer service life than an explosive charge. Such a container may also be instrumented to monitor its state over time, which was not possible in the prior art.

In general, the invention may provide a gain in the actuator response time. The gas, liquid or reagents may be released in a reaction time of the order of a millisecond, for example. The guillotine system according to the invention may also have one or more of the following characteristics, taken alone or in combination with each other:
the pressurized gas is air and/or an inert gas;
the cartridge comprises a closed enclosure, adapted to contain the pressurized gas, and a port, adapted to allow a passage of the pressurized gas;
the actuator comprises, in addition to the pressurized gas, a fuel; this fuel is capable of burning to further increase the pressure of the gas and thus improve the performance of the actuator;
the fuel is associated with an ignition or activation system, preferably connected to said control circuit;
the accumulator comprises a first internal cavity, capable of containing the pressurized liquid, and a second internal cavity, capable of containing pressurized gas and/or an elastic return member, such as a spring, in particular the first internal cavity and the second internal cavity being separated from one another by a membrane, in particular one which is movable and/or deformable;
the first internal cavity comprises an outlet port adapted to allow the passage of liquid for the purpose of moving the blade, and an inlet port adapted to allow a passage of liquid for the purpose of charging and/or recharging the accumulator with liquid;
the inlet port is connected to a source of pressurized liquid, in particular a hydraulic pump, in particular one which is manually operated;
the actuator comprises a container, suitable for containing chemical reagents, in particular separate from one another and suitable for being mixed and/or brought into contact to generate a pressurized gas and ensure a movement of the blade from the first position to the second position;
the chemical reagents are in solid form, in particular one of the chemical reagents being in powder form;
the or each port is equipped with a valve;
the system further comprises a monitoring unit, adapted to allow a monitoring of a state of the actuator;
the monitoring unit comprises at least one sensor and/or is connected to at least one sensor, the sensor being, for example, a pressure sensor;
the guillotine system comprises a body defining the passage;
the guillotine system comprises a chamber connected directly or via a pressurized gas conduit to the actuator;
the blade is carried by a support, in particular a piston, capable of moving in the chamber following the supply of power to the chamber by the actuator, the movement of the support in the chamber causing the blade to move from the first position to the second position;
the guillotine system also comprises a cutting state sensor, capable of confirming that the pipe has been cut; this sensor allows to confirm to the aircraft pilot that the pipe has been cut correctly; in fact, when the pipe is cut, the aircraft has to slow down (as it does during the refueling phase); once the correct cutting state has been indicated, the aircraft may accelerate; today, this confirmation requires a second apparatus, which has to visually confirm that the pipe has been cut correctly;
the cutting status sensor is connected to the monitoring unit;
the monitoring unit comprises a computer, capable of sending an alarm in the event of a fault in the actuator, and in particular a fault in the gas, the pressurized liquid or the reagents, or even capable of receiving signals from the cutting state sensor;
the monitoring unit and/or the cutting sensor is able to send an alarm to the pilot.

The present invention also relates to an in-flight refueling device comprising:
a pipe, configured to allow a fluid transfer, this pipe comprising a first end configured to be connected to a fluid source, and a second end equipped with an in-flight refueling connector,
a system for deploying the pipe, this system being capable of deploying the pipe, in particular winding and unwinding the pipe, to a desired length to ensure an in-flight refueling, and
a guillotine system as described above.

More specifically, the guillotine system may be carried in whole or in part by the deployment system.

This invention also relates to an assembly comprising
an in-flight refueling device as described above,
a source of fluid, such as fuel, connected to the first end of the pipe, and
a control circuit connected to the actuator.

The present invention also relates to an aircraft comprising a guillotine system, an in-flight refueling device or an assembly as described above.

### BRIEF DESCRIPTION OF THE FIGURES

Further characteristics and advantages of the invention will become apparent from the following detailed description, for the understanding of which reference is made to the attached drawings wherein:

FIG. 1 is a schematic view of a refueling aircraft equipped with an in-flight refueling device for an aircraft to be refueled;

FIG. 2 is a perspective view of one embodiment of an in-flight refueling device according to the invention;

FIG. 3 is a schematic view of an embodiment of a guillotine system for an in-flight refueling device according to the invention;

FIG. 4 is a schematic view of a variant embodiment of a guillotine system for an in-flight refueling device according to the invention; and

FIG. 5 is a schematic view of another variant embodiment of a guillotine system for an in-flight refueling device according to the invention.

### DETAILED DESCRIPTION OF THE INVENTION

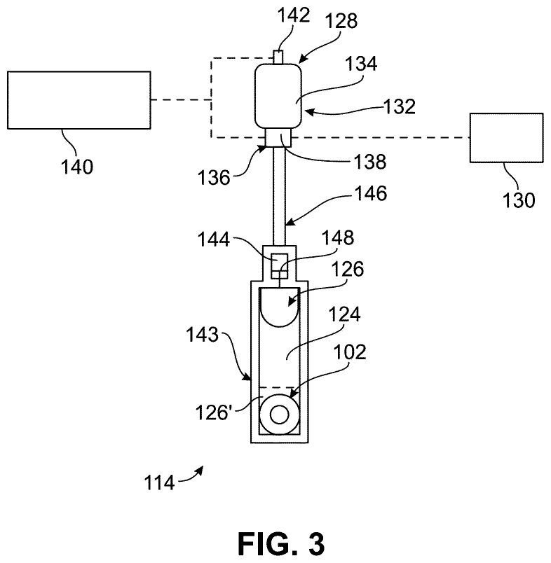

FIGS. 2 and 3 illustrate one embodiment of an in-flight refueling device 100 according to the invention.

More specifically, FIG. 2 is a perspective view of the embodiment of the in-flight refueling device 100 according to the invention.

The in-flight refueling device 100 comprises a pipe 102, configured to allow a fluid transfer, and a cut-off system, in particular a guillotine system 114, configured to allow a refueling to be cut off through the pipe 102 if necessary.

The in-flight refueling device 100 may also comprise a deployment system 104, configured to allow the pipe 102 to be deployed, in particular by winding and unwinding the pipe 102. The pipe 102 comprises a first end 102a, configured to be connected to a fluid source 106, and a second end 102b equipped with an in-flight refueling connector 108.

The pipe 102 is, for example, about ten meters or several tens of meters long, in particular between 10 m and 30 m.

The pipe 102 is preferably a multi-layer pipe comprising, for example, a metal layer, an elastomer layer and a textile layer.

The fluid source 106 may comprise at least one fluid reservoir and a pump. The fluid is, for example, fuel.

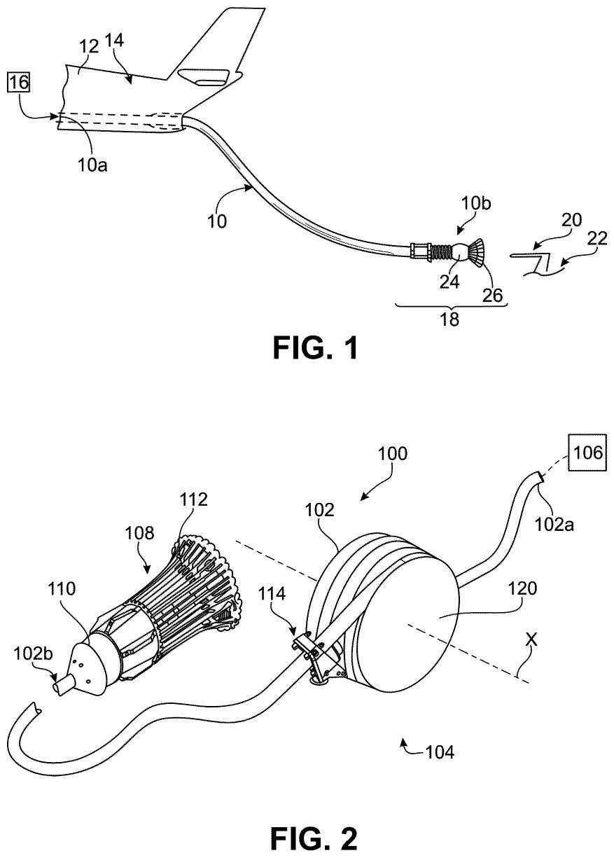

The in-flight refueling connector 108 is of the type described above in relation to FIG. 1 and comprises, for example, a pressure limiting member 110 and a frustoconical basket 112.

The system 104 for deploying the pipe 102 is capable of winding the pipe 102 around an axis X and unwinding it to a desired length to ensure an in-flight refueling. The deployment system 104 is, for example, of the winch type.

The deployment system 104 may comprise a portion for attachment to a structure of the refueling aircraft 14. Such an attachment portion may be, for example, an attachment flange, not shown in the figures.

In one embodiment, the attachment flange may be connected to two parallel arms carrying a drum that is movable about an axis of rotation X. The pipe 102 may be wound around the mobile drum and unwound from the latter.

The guillotine system 114 is preferably carried by the deployment system 104.

In one embodiment, the guillotine system 114 may be attached to a rod connected to the arms carrying the mobile drum. In particular, the rod to which the guillotine system 114 is attached may extend parallel to the axis X of rotation of the mobile drum.

FIG. 3 is a schematic view of an embodiment of a guillotine system 114 for the in-flight refueling device 100 according to the invention. The guillotine system 114 comprises a passage 124, through which the pipe 102 is able to pass. The pipe 102 is able to slide through the passage 124 during the deployment, particularly when the pipe 102 is wound up and unwound.

The guillotine system 114 also comprises a blade 126, which may be moved between
a first position, in which the pipe 102 may slide freely through the passage 124, and
a second position, in which the blade 126 cuts the pipe 102 to sever it in two.

In the non-limiting embodiment shown in FIG. 3, the blade 126 is in the first position, which is a high position in the example shown, and the pipe 102 is at the low position.

When the blade 126 is in the second position, shown as dotted line 126′ in FIG. 3, which is the low position in the example shown, it is therefore level with the pipe 102. When the blade 126 is moved from the first position to the second position, the blade 126 severs or slices the pipe 20, in particular over an entire section of the pipe 20.

The blade 126 is preferably a metal blade.

The guillotine system 114 further comprises an actuator 128, in particular configured to be activated by a control circuit 130, and configured to ensure the displacement of the blade 126 from the first position to the second position.

According to the invention, the actuator 128 is of the non-pyrotechnic type.

According to a first aspect of the invention illustrated in FIG. 3, the actuator 128 comprises a cartridge 132, capable of containing a pressurized gas, such as air, in particular compressed air, and/or a pressurized inert gas. The cartridge 132 contains a volume of pressurized gas, configured to be released following an activation by the control circuit 130. By releasing the pressurized gas, the blade 126 may be moved from the first position to the second position. In addition to pressurized gas, the cartridge may also comprise a fuel to form a hydride actuator. This fuel is capable of burning to further increase the gas pressure and thus improve the performance of the actuator. The fuel is preferably associated with an ignition or activation system which is controlled, for example, by the control circuit 130.

Preferably, the cartridge 132 comprises a closed enclosure 134, capable of containing the pressurized gas. In addition, the cartridge 132 may comprise a port 136, suitable for allowing pressurized gas to pass from the enclosure 134. The port 136 may be equipped with a valve 138.

The guillotine system 114 may also comprise a monitoring unit 140, capable of monitoring a state of the cartridge 132.

The monitoring unit 140 comprises, for example, at least one sensor 142 and/or is connected to a sensor 142. The sensor 142 is, in particular, a pressure sensor.

The monitoring unit 140 may be remote, mounted on the cartridge 132, in particular via the port 136, and/or integrated into the port 136.

The monitoring unit 140 and/or the sensor or sensors 142 may be connected to the port 136, in particular to the valve 138.

The monitoring unit 140 may also comprise or may be connected to at least one pipe cutting state sensor, this sensor being able to confirm that the pipe is cut.

The monitoring unit preferably comprises an on-board computer, capable of sending an alarm in the event of a fault in the actuator, and in particular a fault in the pressurized gas (such as a leak), and also of receiving signals from the cutting state sensor. The monitoring unit is able to send an alarm to the pilot of the aircraft.

In the example shown, the guillotine system 114 comprises a body 143, suitable for defining the passage 124. The body 143 of the guillotine system 114 comprises a chamber 144 connected, directly or by means of a pressurized gas conduit 146, to the cartridge 132, in particular to the port 136, in particular to the valve 138.

The blade 126 is arranged in the passage 124 of the body 143 of the guillotine system 114. The blade 126 may also be carried by a support 148, such as a piston. The support 148 is also able to move within the chamber 144 when the chamber 144 is supplied by the cartridge 132.

The movement of the support 148 in the chamber 144 causes the blade 126 to move from the first position to the second position, thereby cutting the pipe 102.

The in-flight refueling device 100 comprising the guillotine system 114 according to the invention may in particular be arranged:
inside the refueling aircraft 14;
at a downstream end of a fuselage 12 of the refueling aircraft 14;
under a wing of the refueling aircraft 14; and/or
in a carrier, also referred to as a nacelle, installed
   at a ventral point of the refueling aircraft 14, and/or
   under the wing of the refueling aircraft 14.

In addition, according to the invention, the pressurized gas may be contained in the cartridge 132 at a pressure of at least 100 bar. The pressure of the pressurized gas in the cartridge 132 depends on the material, the construction of the pipe 102, the shape of the blade 126 and/or the force to be applied to sever at least part of the pipe 102.

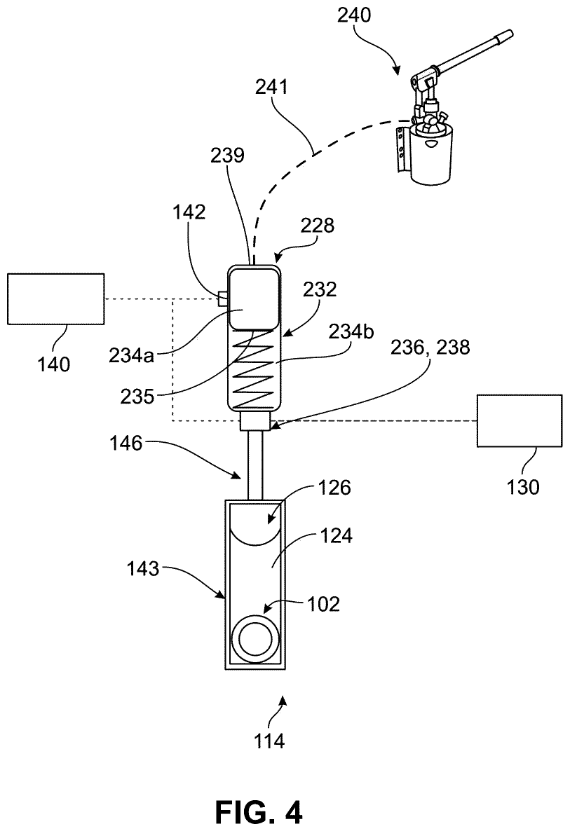

FIG. 4 is a schematic view of a variant embodiment of the guillotine system 114 for the in-flight refueling device 100 according to the invention. The guillotine system 114 further comprises an actuator 228, in particular configured to be activated by a control circuit 130, configured to move the blade 126 from the first position to the second position.

According to the invention, the actuator 228 is of the non-pyrotechnic type.

According to a second aspect of the invention illustrated in FIG. 4, the actuator 228 comprises an accumulator 232, capable of containing a volume of pressurized liquid, such as oil or fuel.

The accumulator 232 contains a volume of pressurized liquid, configured to be released following an activation by the control circuit 130. By releasing the pressurized liquid, the blade 126 may be moved from the first position to the second position.

Preferably, the accumulator 232 comprises a first internal cavity 234a, suitable for containing the pressurized liquid, and a second internal cavity 234b, suitable for containing pressurized gas and/or a resilient return member, such as a spring.

The first internal cavity 234a and the second internal cavity 234b may be separated from each other by a membrane 235, which is in particular mobile and/or deformable.

Preferably, the accumulator 232 comprises a closed enclosure, capable of containing the pressurized liquid, the pressurized gas and/or a return member. In particular, the first internal cavity 234a comprises a closed enclosure, suitable for containing the pressurized liquid, and/or the second internal cavity 234b comprises a closed enclosure, suitable for containing the pressurized gas.

In addition, the first internal cavity 234a may comprise an outlet port 236, suitable for allowing liquid to pass through in order to move the blade 126. In addition, the first internal cavity 234a may comprise an inlet port 239, suitable for allowing liquid to pass through in order to charge and/or recharge the accumulator 232 with liquid.

The outlet port 236 is able to allow pressurized liquid to pass from the first internal cavity 234a. The outlet port 236 may be equipped with a valve 238.

The inlet port 239 is connected to a source of pressurized liquid. In particular, the source of pressurized liquid may be a hydraulic pump 240, in particular a manually-operated pump, comprising and/or connected to a liquid reservoir.

A connection between the inlet port 239 and the hydraulic pump 240 may be made by a flexible pipe 241.

The guillotine system 114 may also comprise a monitoring unit 140, capable of monitoring a state of the accumulator 232.

The monitoring unit 140 comprises, for example, at least one sensor 142 and/or is connected to a sensor 142. The sensor 142 is, in particular, a pressure sensor.

The monitoring unit 140 may be remote, mounted on the accumulator 232, in particular via the port 236, and/or integrated into the port 236.

The monitoring unit 140 and/or the sensor or sensors 142 may be connected to the port 236, in particular to the valve 238.

The monitoring unit 140 may also comprise or may be connected to at least one pipe cutting state sensor, this sensor being able to confirm that the pipe is cut.

The monitoring unit preferably comprises an on-board computer, capable of sending an alarm in the event of a fault in the actuator, and in particular a fault in the pressurized liquid (such as a leak), and also of receiving signals from the cutting state sensor. The monitoring unit is able to send an alarm to the pilot of the aircraft.

In the example shown, the guillotine system 114 comprises a body 143, suitable for defining the passage 124. As mentioned above, the body 143 of the guillotine system 114 may comprise a chamber connected, directly or by means of a pressurized liquid conduit 146, to the accumulator 232, in particular to the port 236, in particular to its valve 238. The blade 126 is arranged in the passage 124 of the body 143 of the guillotine system 114. The blade 126 may also be carried by a support, such as a piston. As mentioned above, the support may also be able to move within a chamber, following power supply to the chamber by the accumulator 232.

The movement of the support in the chamber causes the blade 126 to move from the first position to the second position, thereby cutting the pipe 102.

The in-flight refueling device 100 comprising the guillotine system 114 according to the invention may in particular be arranged:
inside the refueling aircraft 14;
at a downstream end of a fuselage 12 of the refueling aircraft 14;
under a wing of the refueling aircraft 14; and/or
in a carrier, also referred to as a nacelle, installed
   at a ventral point of the refueling aircraft 14, and/or
   under the wing of the refueling aircraft 14.

In addition, according to the invention, the pressurized liquid may be contained in the accumulator 232 at a pressure of at least 100 bar. The pressure of the pressurized liquid in the accumulator 232 depends on the material, the construction of the pipe 102, the shape of the blade 126 and/or the force to be applied to sever at least part of the pipe 102.

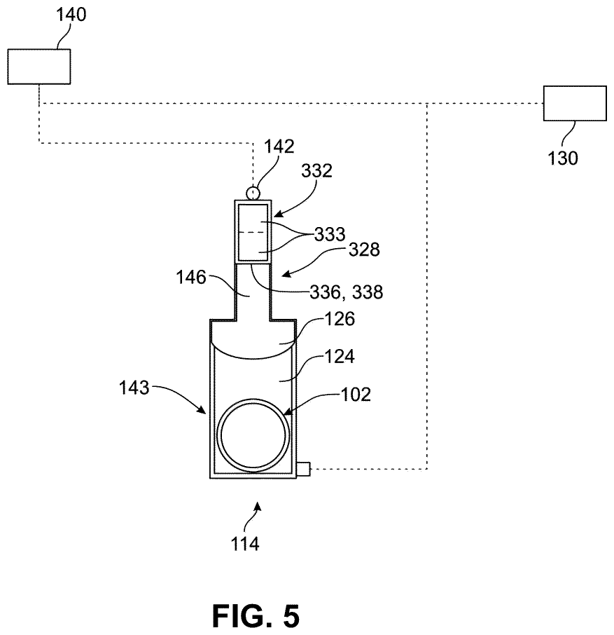

FIG. 5 is a schematic view of another variant embodiment of the guillotine system 114 for the in-flight refueling device 100 according to the invention.

The guillotine system 114 also comprises an actuator 328, in particular configured to be activated by a control circuit 130, and configured to move the blade 126 from the first position to the second position.

According to the invention, the actuator 328 is of the non-pyrotechnic type.

According to a third aspect of the invention illustrated in FIG. 5, the actuator 328 comprises a container 332, suitable for containing chemical reagents 333.

In a particular embodiment, the chemical reagents 333 are separated from each other and may be mixed and/or brought into contact to generate and release a pressurized gas. By releasing the pressurized gas, the blade 126 may be moved from the first position to the second position.

The chemical reagents 333 are, for example, in solid form, one of the chemical reagents 333 being, in particular, in powder form.

The container 332 contains a volume of chemical reagents 333, configured so as, after mixing, to generate a pressurized gas capable of being released following an activation by the control circuit 130. By releasing the pressurized gas, the blade 126 may be moved from the first position to the second position.

Preferably, the container 332 comprises a closed enclosure capable of containing the pressurized gas. In addition, the container 332 comprises a port 336, capable of allowing pressurized gas to pass to the outside of the container 332. The port 336 may be equipped with a valve 338.

The guillotine system 114 may also comprise a monitoring unit 140, suitable for monitoring a state of the container 332. The monitoring unit 140 comprises, for example, at least one sensor 142 and/or is connected to a sensor 142. The sensor 142 is, in particular, a pressure sensor.

The monitoring unit 140 may be remote, mounted on the container 332, in particular via the port 336, and/or integrated into the port 336.

The monitoring unit 140 and/or the sensor or sensors 142 may be connected to the port 336, in particular to its valve 338.

The monitoring unit 140 may also comprise or may be connected to at least one pipe cutting state sensor, this sensor being able to confirm that the pipe is cut.

The monitoring unit preferably comprises an on-board computer, capable of to send an alarm in the event of a reagent fault, and also to receive signals from the cutting state sensor. The monitoring unit is able to send an alarm to the pilot of the aircraft.

In the example shown, the guillotine system 114 comprises a body 143, suitable for defining the passage 124. As mentioned above, the body 143 of the guillotine system 114 may comprise a chamber connected, directly or by means of a pressurized gas conduit, to the container 332, in particular to its port 336, notably to the valve 338.

The blade 126 is arranged in the passage 124 of the body 143 of the guillotine system 114. The blade 126 may also be carried by a support, such as a piston. As mentioned above, the support may also be able to move within a chamber as a result of the chamber being supplied by the container 332.

The movement of the support in the chamber causes the blade 126 to move from the first position to the second position, thereby cutting the pipe 102.

The in-flight refueling device 100 comprising the guillotine system 114 according to the invention may in particular be arranged:
inside the refueling aircraft 14;
at a downstream end of a fuselage 12 of the refueling aircraft 14;
under a wing of the refueling aircraft 14; and/or
in a carrier, also referred to as a nacelle, installed
   at a ventral point of the refueling aircraft 14, and/or
   under the wing of the refueling aircraft 14.

In addition, according to the invention, the pressurized gas may be generated in the container 332 at a pressure of at least 100 bar. The pressure depends on the material, the construction of the pipe 102, the shape of the blade 126 and/or the force to be applied to sever at least part of the pipe 102.

The advantages of the invention are numerous and include, for example:
less maintenance, as the guillotine system 114 no longer requires checking before each flight and after each return flight of the refueling aircraft 14. In addition, the cartridge 132 and/or the actuator 128, 228, 328 no longer comprise a time limit for use;
greater reliability, as daily assembly and disassembly work on the guillotine system 114 is eliminated;
increased availability and flight safety, as the guillotine system 114 may be monitored by means of feedback on the pressure inside the cartridge 132 and/or the state of the actuator 128, 228, 328. This eliminates the occurrence of a failure, guaranteeing a better availability rate of an essential safety function so that the refueling aircraft 14, in the event of a failure of the in-flight refueling device 100, may land or land with complete peace of mind;
simpler marketing, as the guillotine system 114 is no longer subject to restrictive regulations;
etc.

1. A guillotine system, in particular for an in-flight refueling device, comprising:
a passage configured to have a pipe pass therethrough,
a blade movable between:
a first position, in which the pipe slides freely through the passage, and
a second position, in which the blade is configured to cut the pipe, and
an actuator configured to move the blade from the first position to the second position,
wherein said actuator is of the non-pyrotechnic type and is configured to contain and/or generate a pressurized fluid released to move the blade from the first position to the second position, the actuator comprising an accumulator configured to contain a volume of pressurized liquid, the system further comprising a monitoring unit configured to allow a monitoring of a state of the actuator, and the accumulator comprises a first internal cavity configured to contain the pressurized liquid, and a second internal cavity configured to contain pressurized gas and/or an elastic return member, in particular the first internal cavity and the second internal cavity being separated from one another by a membrane, in particular one which is movable and/or deformable.

2. The guillotine system according to claim 1, wherein the actuator comprises a cartridge configured to contain a volume of a pressurized gas, in particular air and/or an inert gas.

3. The guillotine system according to claim 2, wherein the cartridge comprises a closed enclosure configured to contain the pressurized gas, and a port configured to allow a passage of the pressurized gas.

4. (canceled)

5. (canceled)

6. The system according to claim 1, wherein the first internal cavity comprises an outlet port configured to allow a passage of liquid that moves the blade, and/or an inlet port configured to allow a passage of liquid that charges and/or recharges the accumulator with liquid.

7. The system according to claim 6, wherein the inlet port is connected to a source of pressurized liquid, in particular a hydraulic pump, in particular one which is manually operated.

8. The guillotine system according to claim 1, wherein the actuator comprises a container configured to contain chemical reagents, in particular separate from one another and suitable for being mixed and/or brought into contact to generate a pressurized gas.

9. The guillotine system according to claim 8, wherein the chemical reagents are in solid form, in particular one of the chemical reagents being in powder form.

10. The guillotine system according to claim 1, wherein the monitoring unit comprises at least one sensor and/or is connected to at least one sensor.

11. The guillotine system according to claim 1, wherein the guillotine system comprises a chamber connected to the actuator.

12. The guillotine system according to claim 1, wherein the blade is carried by a support configured to move in the chamber following a supply of power to the chamber by the actuator, the movement of the support in the chamber causing the blade to move from the first position to the second position.

13. The guillotine system according to claim 1, further comprising a cutting state sensor configured to confirm that the pipe has been cut.

14. An in-flight refueling device comprising:
a pipe, configured to allow a fluid transfer, this pipe comprising a first end, configured to be connected to a fluid source, and a second end equipped with an in-flight refueling connector, and
a deployment system configured to deploy the pipe, in particular winding and unwinding the pipe, to a desired length to ensure an in-flight refueling, and
the guillotine system according to claim 1.

15. The in-flight refueling device according to claim 14, wherein the guillotine system is carried in whole or in part by the deployment system.

16. An assembly comprising:
the in-flight refueling device according to claim 14,
a source of fluid, such as fuel, connected to the first end of the pipe, and
a control circuit connected to the actuator.

17. An aircraft comprising the guillotine system according to claim 1.

18. An aircraft comprising the in-flight refueling device according to claim 14.

19. An aircraft comprising the assembly according to claim 16.

20. The guillotine system according to claim 1, wherein the blade is configured to sever the pipe into two pieces when the blade is in the second position.
